(19) United States
(12) Patent Application Publication
(10) Pub. No.: US 2012/0124551 A1
(43) Pub. Date: May 17, 2012

(54) TEMPLATE INHERITANCE IN A CONFIGURATION OBJECT MODEL

(75) Inventor: Bryan Alexander Holzbauer, Gardnerville, NV (US)

(73) Assignee: GENERAL ELECTRIC COMPANY, Schenectady, NY (US)

(21) Appl. No.: 12/944,440

(22) Filed: Nov. 11, 2010

(51) Int. Cl. G06F 9/44

(52) U.S. Cl. 717/104

(57) ABSTRACT

A method for generating templates in a programming environment can include generating a first template having a plurality of object type definitions, defining properties for the object type definitions within the first template and deriving a second template from the first template, wherein the properties of the first template are defined in the second template, wherein the first template includes a link to a template link object in the second template.

### BACKGROUND OF THE INVENTION

The subject matter disclosed herein relates to object-oriented programming and, more particularly, to systems, methods and computer program products for template inheritance in a configuration object model.

In a configuration object model, templates are logical collections of object instances whose purpose is to allow the easy creation of object collections. Templates can contain one or more object instances as well as links to other templates to include in the owning template. Template inheritance is a modeling concept in which templates may be derived from other templates, objects within a derived template can be derived from objects in a parent template, and links to other templates in a template can be overridden in a derived template. In order to make changes within a template to define template characteristics such as new object instances and new template links, a new template must be defined.

### BRIEF DESCRIPTION OF THE INVENTION

According to one aspect of the invention, a method for generating templates in a configuration object model is disclosed. The method can include generating a first template having object definitions, defining properties for the object definitions within the first template and deriving a second template from the first template, wherein a subset of the object definitions from the first template are defined as being derived from objects in the first template

According to another aspect of the invention, a computer program product for generating templates in an object oriented programming environment, the computer program product having a computer readable medium including instructions for causing a computer to implement a method is disclosed. The method can include generating a first template having object definitions, defining properties for the object definitions within the first template and deriving a second template from the first template, wherein the properties of the first template are defined in the second template, wherein the first template includes a link to a template link object in the second template.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an example of a template structure in accordance with exemplary embodiments;

FIG. 2 illustrates an example of a resultant set of object instances that is created if the inherited template of FIG. 1 is instantiated;

FIG. 3 illustrates an example of a base template linked with another template;

FIG. 4 illustrates an example of a resultant set of object instances that is created if the inherited template of FIG. 3 is instantiated;

FIG. 5 illustrates an example of a parent template and an inherited template;

FIG. 6 illustrates an example of a resultant object instance that is created if the inherited template of FIG. 5 is instantiated;

FIG. 7 illustrates an example of a parent template and an inherited template with different object types;

FIG. 8 illustrates an example of a resultant object instance that is created if the inherited template of FIG. 7 is instantiated;

FIG. 9 illustrates an example of a parent template with a template link to another template and a derived template that is derived from the initial parent template and contains a template link that derives from the template link in the parent template.

FIG. 10 illustrates an example of a resultant set of object instances that is created if the inherited template of FIG. 9 is instantiated;

FIG. 11 illustrates an example of multiple parent templates that each has derived templates with multiple template links between the templates.

FIG. 12 illustrates an example of a resultant set of object instances that is created if the inherited template of FIG. 11 is instantiated;

FIG. 13 illustrates an example of a complex set of templates and template links where there are multiple levels of derived templates under a single parent template.

FIG. 14 illustrates an example of a resultant set of object instances that is created if the inherited template of FIG. 13 is instantiated;

FIG. 15 illustrates an example of multiple parent templates that each have derived templates in which additional objects and references to derived templates are added;

FIG. 16 illustrates an example of a resultant set of object instances that is created if the inherited template of FIG. 15 is instantiated; and

FIG. 17 illustrates an exemplary embodiment of a system in which the template inheritance and linking methods can be implemented.

The detailed description explains embodiments of the invention, together with advantages and features, by way of example with reference to the drawings.

### DETAILED DESCRIPTION OF THE INVENTION

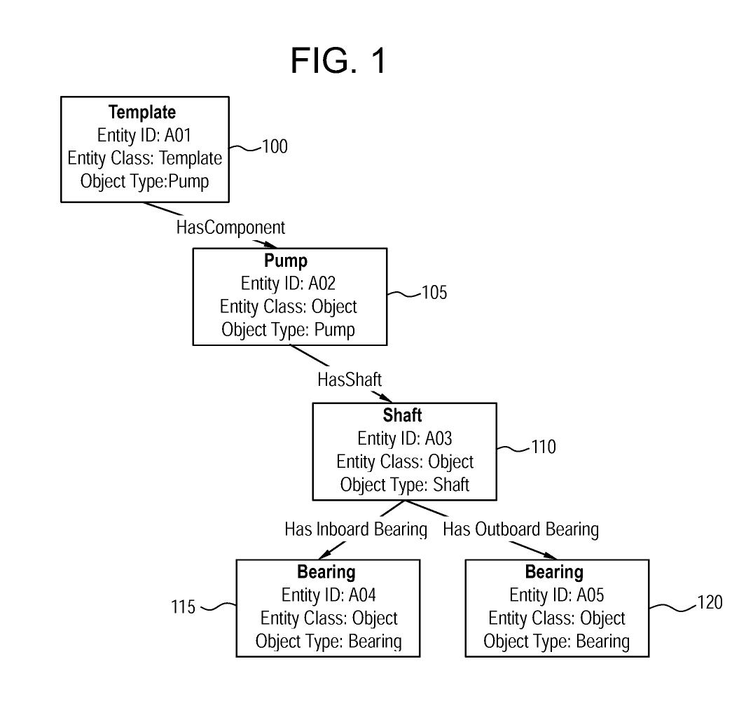

FIG. 1 illustrates a diagram of a basic structure of a template 100 which can be modified to include exemplary template inheritance as described herein. Inheritance is the object-oriented software development concept of the creation of new types of objects (i.e., classes) from other objects. Template inheritance allows for the application of the inheritance concept from object-oriented design methodologies to templates. For purposes of discussion, a template is a collection of one or more object instances in a configuration object model. These templates are implemented to create copies of this set of object instances in a client's instance configuration data store. In exemplary embodiments, the systems and methods described herein define new templates that derive properties from an original template without having to re-define all of the properties that were defined in the original template, which results in smaller template databases since the properties don't have to be redefined in each template. With conventional templates, full sets of object instances are defined for every template. In exemplary embodiments, the systems and methods described herein can also define the inheritance at each individual object in the template rather than defining the inheritance at the entire template. For illustrative purposes the application of templates and template inheritance is discussed with respect to pumps having base templates with common properties that may be changed via inherited templates including just the changed properties.

A template can include a single template entity and a set of object instance entities. The template entity has to have a reference to at least one object instance entity using a HasComponent reference type. For example, as illustrated in FIG. 1, a base template 100 includes a pump template 105, a shaft template 110 and two bearings templates 115, 120. The object type on the template entity 100 is implemented to identify what each template includes. When there are multiple objects referenced directly under a template, any one of these “root” object types can be selected as the object type for the template or a new object type can be specified (e.g., if a template contains both a Pump and a Monitoring Device, you could specify either “Pump” or “Monitoring Device” or “Pump with Monitoring Device” as the object type of the template).

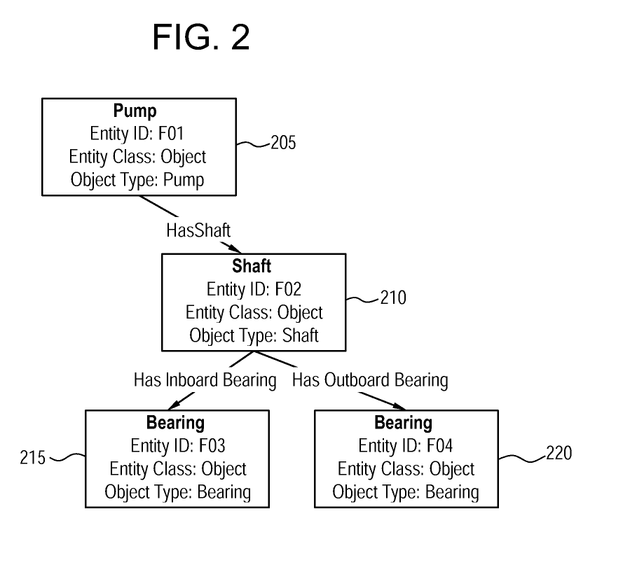

When a new set of objects is created from a template, all of the instance entity IDs in the new objects are replaced with new instance entity IDs. As a result, all of the references are also updated to use the new IDs. From FIG. 1, the entity IDs of the objects 105, 110, 115, 120 are initially A02, A03, A04, A05, respectively. When an instance of the templates are generated, the resultant set of instance entities are illustrated in FIG. 2 in which instances of the templates are now F01, F02, F03, F04 for the template and objects 205, 210, 215, 220, respectively.

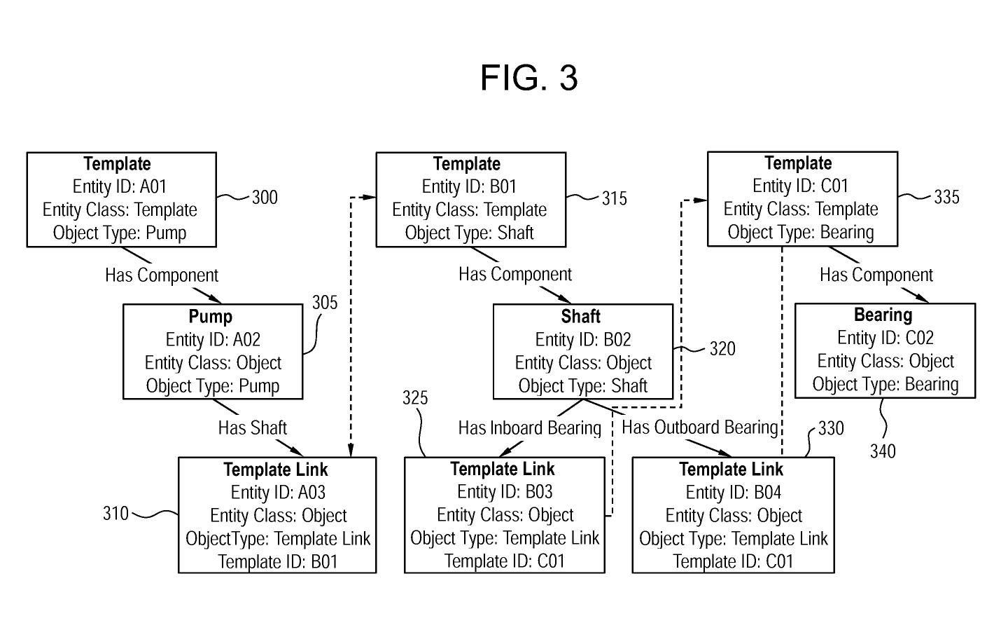

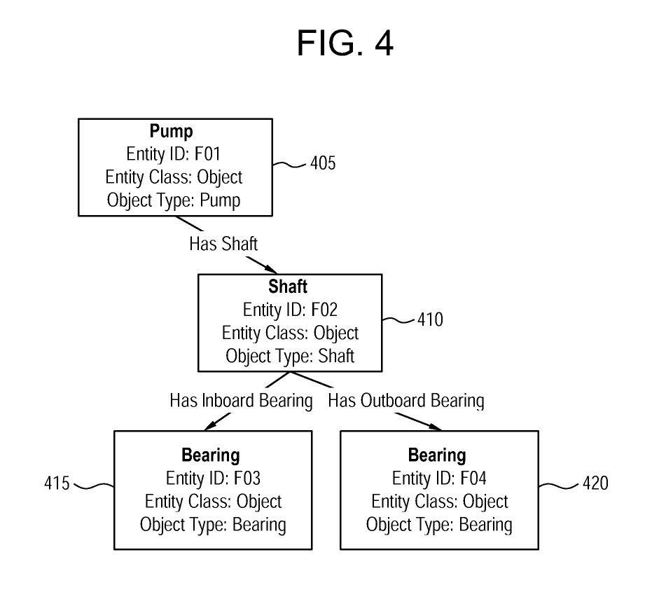

The template model allows for templates to be composed of other templates through template linking via template link objects in the template. In exemplary embodiments, a template can contain links to other templates to include in its template. Furthermore, these template links can be replaced through this template inheritance system by creating a new template link in a derived template that is defined as being derived from a template link in a parent template. A template link object is replaced with object instances from another template. Each template link object has a “Template ID” property that specifies the entity ID of the template that includes the objects that are to be put in place of the template link object. There is no limit to the number of template link objects that can be placed in a template. There is also no limit to the depth of template links that can be chained together (e.g. machine train linked to machine templates, which are linked to shaft templates, which are linked to bearing templates and the like). When a set of object instances are created from a template, the template entities and template link objects are removed so that only the object instance entities remain. For example, FIG. 3 illustrates a chain of templates 300, 315, 335 linked illustrating template linking that can be implemented from FIG. 1, as now described. In FIG. 1 the shaft object 110 is replaced with the template link 310, which corresponds to the template 315 that has the shaft object 320. From FIG. 1, the shaft template had bearing templates 115, 120, which are now replaced with template links 325, 330, respectively, both of which correspond to the template 335 which has the bearing object 340. As such, in the example in FIG. 3, the first template 300 includes only the pump object 305 and the template link object 310. The first template link object 310 has the TemplateID property that specifies that the Shaft template 315 is to be created in place of the template link object 310. The shaft object 320 includes two template links, one for the inboard bearing and one for the outboard bearing. Both template link objects 325, 330 have a TemplateID property set to the ID of the Bearing template 335, which causes two instances of the bearing template to be created and linked under the shaft object 320. When an instance of the bearing template 335 is created, the resultant set of instance entities created is illustrated in FIG. 4 showing the pump object 405, the shaft object 410 and two bearing objects 415, 420. Changing an object within a template may impact other templates if it is being referenced by a template link in another template. As such, when making changes to a template, all links to the template being modified are evaluated to ensure that the change is correct for all of the affected templates.

Template inheritance allows templates to be defined as being “derived from” a parent template or a series of parent templates. When a template is defined as deriving from another template or series of templates, the derived template inherits all of the properties and referenced objects of the parent template(s). If a property exists in an object in both the derived template as well as in the parent templates, the derived object's property value takes precedence over the parent templates. The convention model for templates only supports the addition of properties or changing the value of properties on entities. In exemplary embodiments, this property is expanded to support adding and changing references in derived templates.

Template inheritance is modeled by creating multiple templates and implementing IsDerivedFrom references between the template entities as well as between the object entities that have changes. References are therefore included on both the template entities and the object entities. The reference is on the template entity so that the derived template doesn't have to include all of the objects that are defined in the parent template. The reference on the object entities is to specify the object in the parent template to which the inherited template is making changes.

Template inheritance also follows additional rules including but not limited to: 1) If the object type is changed in the derived template, it must follow the object type hierarchy (e.g. a pump template cannot derive from a bearing template); and 2) Multiple levels of inheritance is supported (e.g. having Plain Sleeve Fluid Film Bearing template, which derives from a Fluid Film Bearing template which derives from a base Bearing template)

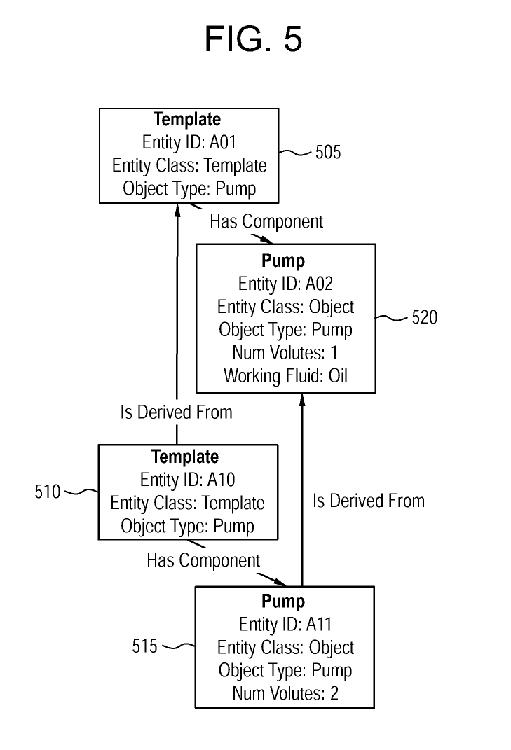

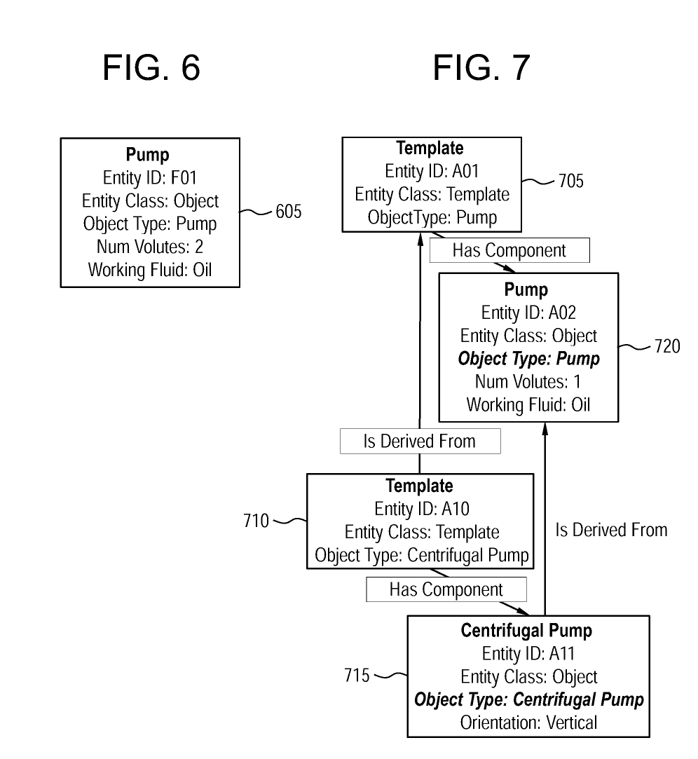

Exemplary template inheritance is illustrated in FIG. 5, which illustrates an example of two pump templates 505, 510 where one is derived from the other. The template 505 has the pump object 520. The derived pump 515 only contains the NumVolutes property with a value of 2. With exemplary template inheritance, the derived template 510 inherits all of the properties (and references) from the inherited template 505. When an instance of the derived template 510 is created, the resultant pump object 505 that is created is illustrated in FIG. 6

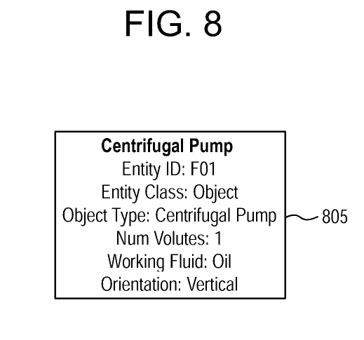

In exemplary embodiment, template inheritance with derived objects enables changing object types between the parent and the derived templates as illustrated in FIG. 7. In exemplary embodiments, derived object types are in an object type hierarchy. In the example in FIG. 7, the example includes a template 705 with an ObjectType of pump and a template 710 with an ObjectType of centrifugal pump. In exemplary embodiments, the centrifugal pump object 715 type must be derived from the pump object 720 type in the object type hierarchy for these templates to be valid. If this derived template 710 (with EntityID: A10) is created, the resultant object 805 is illustrated in FIG. 8.

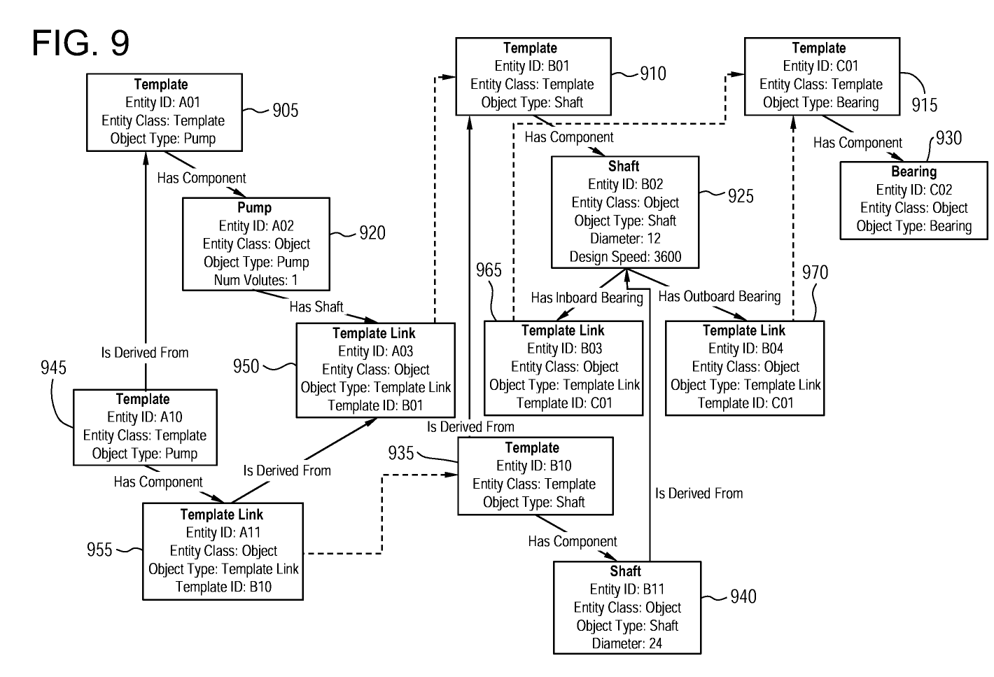

In exemplary embodiments, template inheritance and template linking can be combined. FIG. 9 illustrates an example with a base set of three linked templates 905, 910, 915 for a pump 920, shaft 925, and a bearing 930. The example includes a derived shaft template 935 from the template 900, and a derived shaft object 940 from the shaft object 925, showing a change to a single property (i.e., diameter) on the shaft object 925.

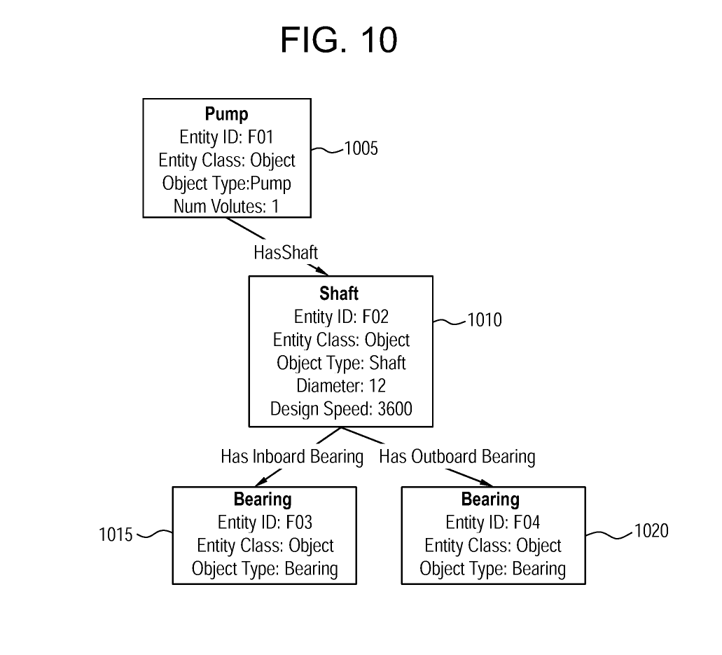

In the example of FIG. 9, the base template 905 includes a pump object 920, template link object 950 to a shaft object 925, and two template link objects (965,970) to a bearing object 930. A new derived pump template 945 with a template link 955 to a derived shaft template 935 with derived shaft object 940 with a different shaft diameter is created. First, a derived template 945 is created that inherits the pump object 920 and the inherited template link object 955 that is inherited from the parent template link object 950. The derived pump template 945 does not include the pump object 920 since none of the properties on the pump object 920 are modified. The template link 950 is changed to point to a new shaft template 935 that has the new diameter property value, by defining a template link object 955 in the derived template 945 and points to the derived shaft template 935. In addition, an “IsDerivedFrom” reference is created to the base template link object 950 that is overridden. As such, the derived shaft template 935 is defined with reference to the base shaft template 900 so that the Design Speed property is inherited as well as the two bearing template links 965, 970. We then define the derived shaft object 940 with the property values that are overridden in the base shaft template 910. As such, the diameter property is changed from 12 to 24. Note that the derived shaft template 935 does not contain the bearing template link objects because they were not modified by the derived template. When an instance of the derived template 945 is created, the resultant set of objects that is created is illustrated in FIG. 10 showing the pump object 1005, the shaft object 1010 and two bearing objects 1015, 1020.

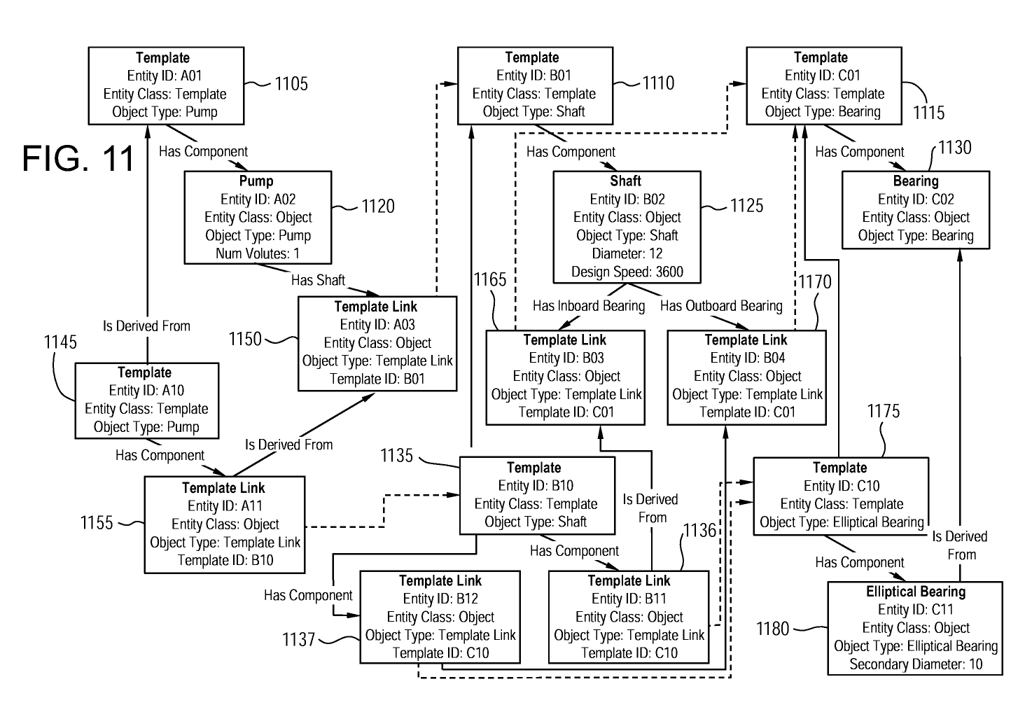

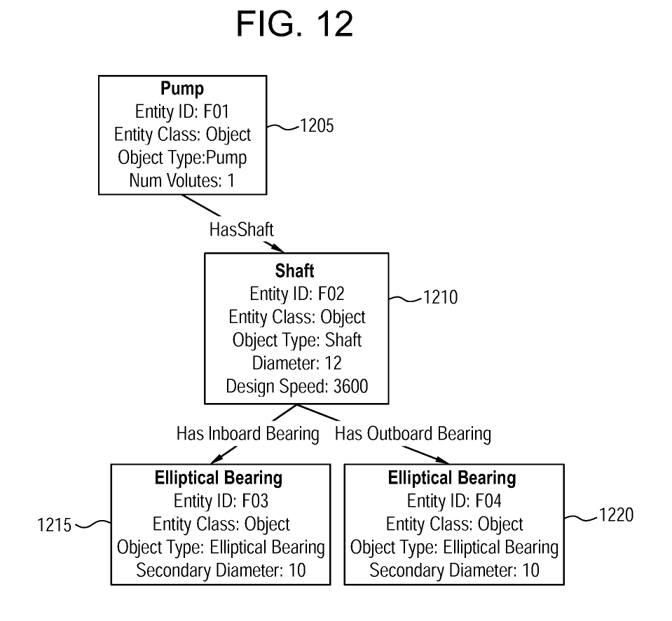

FIG. 11 illustrates another example of template inheritance with template linking in accordance with exemplary embodiments. The example includes a base set of three linked templates 1105, 1110, 1115 for a pump 1120, a shaft 1125, and a bearing 1130. The example includes a derived shaft template 1135 from the template 1110, a shaft object 1125 that is not overridden in the derived template, and two derived template link objects. In addition, the template link 1150 is changed to point to a new shaft template 1135 that has the two derived template link objects by adding a template link object 1155 to the derived template 1145 that points to the derived shaft template 1135. In the example, the bearing object 1130 in template 1115 is inherited by an elliptical bearing object 1180 which is in the inherited template 1175 and contains an additional property of SecondaryDiameter. In the example, the derived shaft template 1135 is modified. Instead of having a derived shaft object (940 in FIG. 9) with a different diameter value than in a parent template (925 in FIG. 9), two template link objects 1136, 1137 are created, both pointing to the derived elliptical bearing template 1175. Each of these template link objects 1136, 1137 has its own IsDerivedFrom reference to the associated derived template link objects 1165, 1170. A shaft object (940 in FIG. 9) does not need to exist in the derived shaft template 1135 because none of the properties on the shaft needed to be modified. As such, the derived pump template 1145 is modified to have a shaft with two elliptical bearings. When an instance of the derived template 1145 is created, the resultant set of objects that is created is illustrated in FIG. 12 including a pump object 1205, a shaft object 1210 and two elliptical bearing objects 1215, 1220.

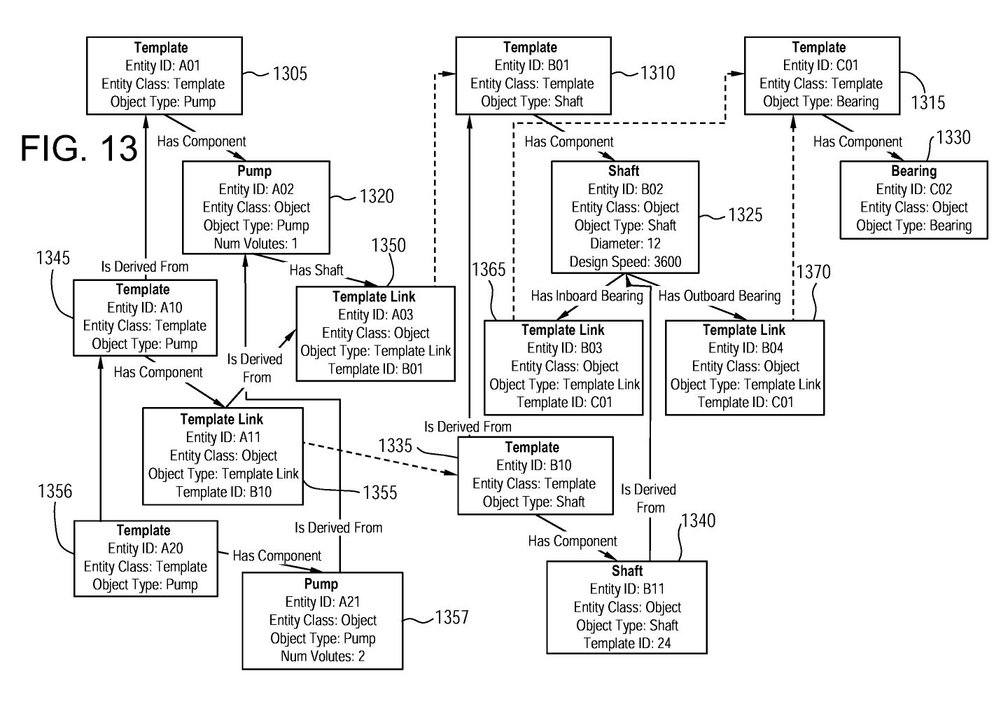

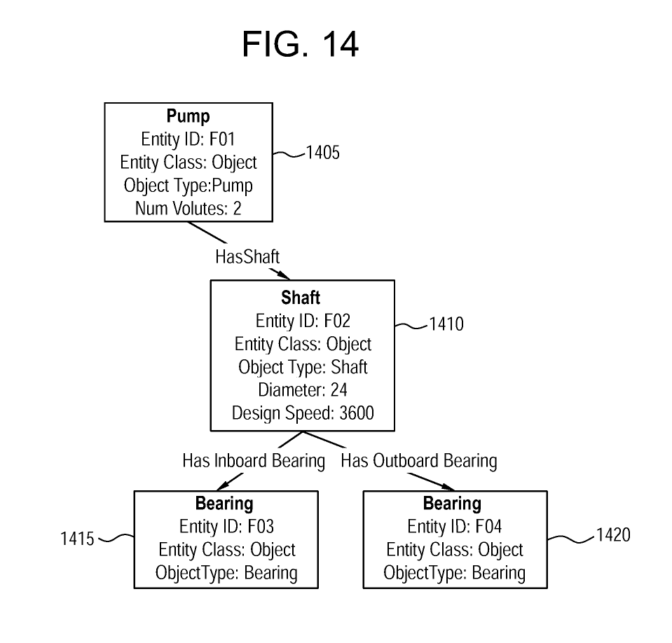

FIG. 13 illustrates another example of template inheritance with template linking in accordance with exemplary embodiments. The example includes a base set of three linked templates 1305, 1310, 1315 for a pump 1320, shaft 1325, and a bearing 1330. The example includes a derived shaft template 1335 from the template 1310, and a shaft object 1340 showing a change to a single property (i.e., diameter) on the shaft object 1325. In addition, the template link 1350 points to a shaft template 1310 that has the parent diameter property value. A template link object 1355 is added to the derived template 1345 and points to the derived shaft template 1335. Furthermore, the derived shaft template 1335 is defined with reference to the base shaft template 1310 so that the Design Speed property is inherited as well as the two bearing template links 1365, 1370 as in the previous examples. The example in FIG. 13 illustrates multiple levels of template derivations including three pump templates 1305, 1345, 1356. The example thus includes a first derived template 1345 and a second derived template 1356 under the first derived template 1305 for the purpose of changing the referenced shaft object in the first derived pump template 1345 as well as changing the NumVolutes property in the second derived pump template 1356. The example illustrates that a new derived template 1356 can be generated that inherits all of the inherited template object definitions from multiple base templates 1305, 1345 with the ability to change properties in the derived objects (e.g. changing the NumVolutes property from a value of 1 from the inherited pump object 1320 to a value of 2 as seen in the template link 1357). When an instance of the derived template 1356 is created, the resultant set of objects that is created is illustrated in FIG. 14 including a pump object 1405, a shaft object 1410 and two elliptical bearing objects 1415, 1420.

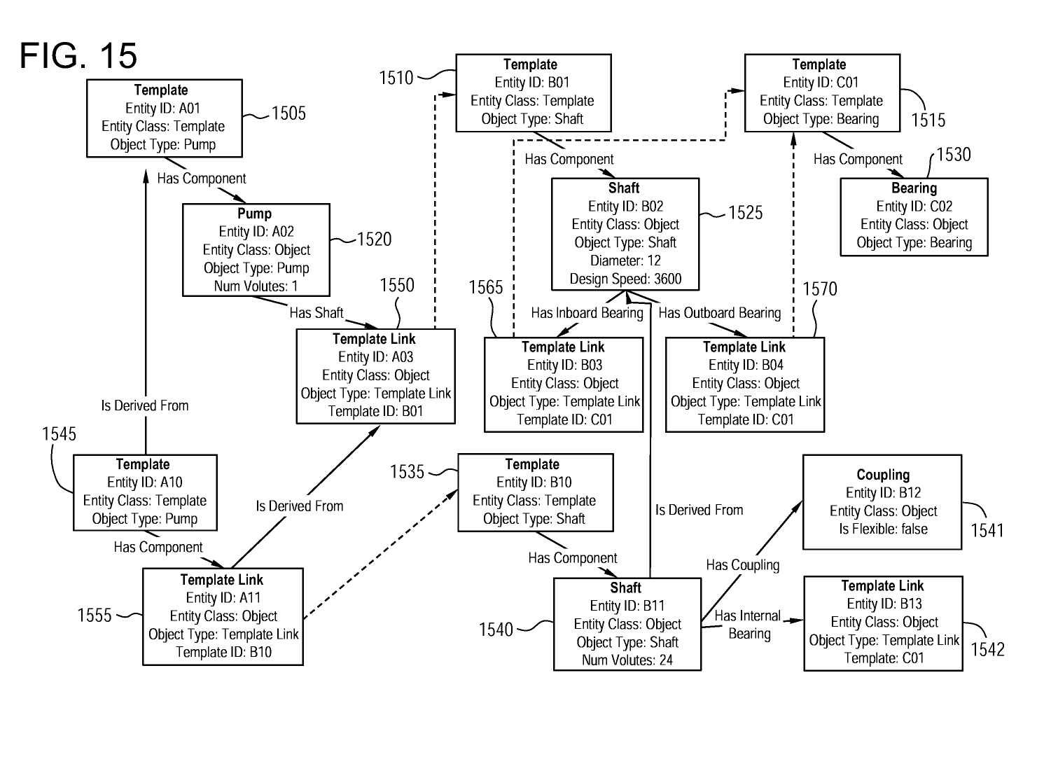

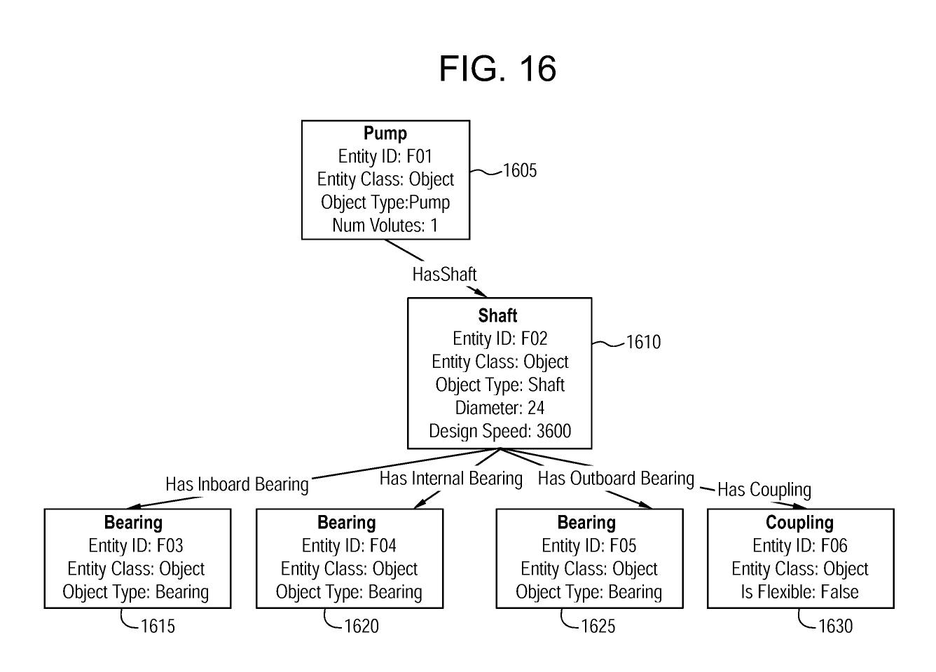

FIG. 15 illustrates another example of template inheritance with template linking in accordance with exemplary embodiments. The example includes a base set of three linked templates 1505, 1510, 1515 for a pump 1520, shaft 1525, and a bearing 1530. The example includes a derived shaft template 1535 from the template 1510, and a shaft object 1540 showing a change to a single property (i.e., diameter) on the shaft object 1525. In addition, the template link 1550 points to a shaft template 1510 that has the parent diameter property value. A template link object 1555 is added to the derived template 1545 and points to the derived shaft template 1535. Furthermore, the derived shaft template 1535 is defined with reference to the base shaft template 1510 so that the Design Speed property is inherited as well as the two bearing template links 1565, 1570 as in the previous examples. The example in FIG. 15 illustrates adding objects including a coupling object 1541 and references to templates including a template link 1542 in accordance with exemplary embodiments. The example illustrates the derived shaft object 1540 that creates a reference to a new template link 1542 (e.g., a third bearing) as well as a reference to a new non-template link object (i.e., the coupling object 1541). When an instance of the derived template 1545 is created, the resultant set of objects that is created is illustrated in FIG. 16 including a pump object 1605, a shaft object 1610 and three bearing objects 1615, 1620, 1625 and a coupling 1630.

The exemplary template inheritance and linking methods described herein can be implemented in programming environments that can advantageously reside in computer systems, an example of which is now described.

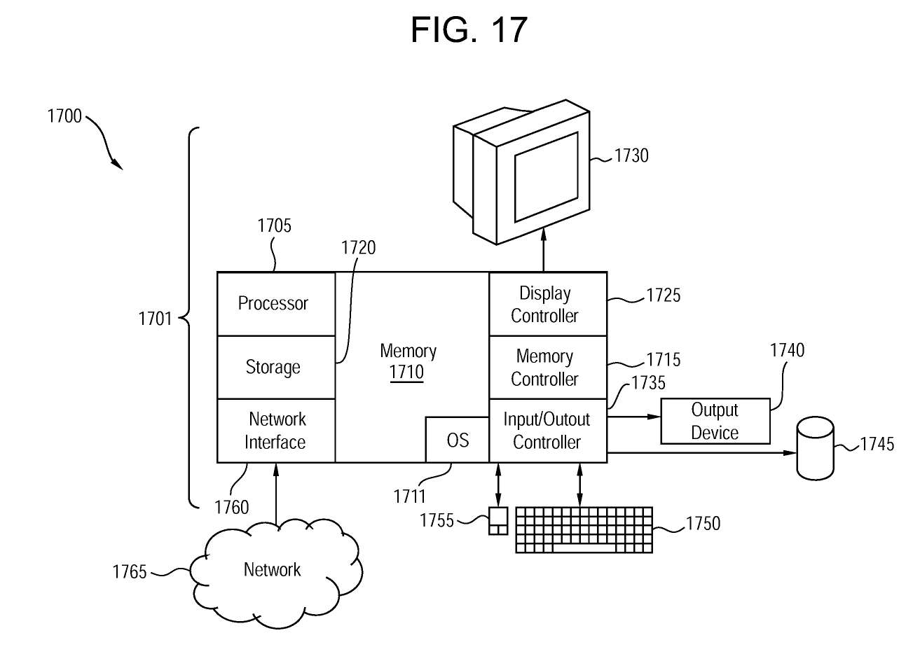

FIG. 17 illustrates an exemplary embodiment of a system 1700 in which the template inheritance and linking methods can be implemented. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 1700 therefore includes general-purpose computer 1701.

In exemplary embodiments, in terms of hardware architecture, as shown in FIG. 17, the computer 1701 includes a processor 1705, memory 1710 coupled to a memory controller 1715, and one or more input and/or output (I/O) devices 1740, 1745 (or peripherals) that are communicatively coupled via a local input/output controller 1735. The input/output controller 1735 can be, but is not limited to, one or more buses or other wired or wireless connections, as is known in the art. The input/output controller 1735 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1705 is a hardware device for executing software, particularly that stored in memory 1710. The processor 1705 can be any custom made or commercially available processor, a central processing unit (CPU), an auxiliary processor among several processors associated with the computer 1701, a semiconductor based microprocessor (in the form of a microchip or chip set), a macroprocessor, or generally any device for executing software instructions.

The memory 1710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1710 may incorporate electronic, magnetic, optical, and/or other types of storage media. Note that the memory 1710 can have a distributed architecture, where various components are situated remote from one another, but can be accessed by the processor 1705.

The software in memory 1710 may include one or more separate programs, each of which comprises an ordered listing of executable instructions for implementing logical functions. In the example of FIG. 17, the software in the memory 1710 includes the template inheritance and linking methods described herein in accordance with exemplary embodiments and a suitable operating system (OS) 1711. The operating system 1711 essentially controls the execution of other computer programs, such the template inheritance and linking systems and methods as described herein, and provides scheduling, input-output control, file and data management, memory management, and communication control and related services.

The template inheritance and linking methods described herein may be in the form of a source program, executable program (object code), script, or any other entity comprising a set of instructions to be performed. When the source code for a program is written, the source code needs to be translated via a compiler, assembler, interpreter, or the like, which may or may not be included within the memory 1710, so as to operate properly in connection with the OS 1711. Furthermore, the template inheritance and linking methods can be written in an object oriented programming language, which has classes of data and methods, or a functional or procedural programming language, which has routines, subroutines, and/or functions.

In exemplary embodiments, a conventional keyboard 1750 and mouse 1755 can be coupled to the input/output controller 1735. Other output devices such as the I/O devices 1740, 1745 may include input devices, for example but not limited to a printer, a scanner, microphone, and the like. Finally, the I/O devices 1740, 1745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 1700 can further include a display controller 1725 coupled to a display 1730. In exemplary embodiments, the system 1700 can further include a network interface 1760 for coupling to a network 1765. The network 1765 can be an IP-based network for communication between the computer 1701 and any external server, client and the like via a broadband connection. The network 1765 transmits and receives data between the computer 1701 and external systems. In exemplary embodiments, network 1765 can be a managed IP network administered by a service provider. The network 1765 may be implemented in a wireless fashion, e.g., using wireless protocols and technologies, such as WiFi, WiMax, etc. The network 1765 can also be a packet-switched network such as a local area network, wide area network, metropolitan area network, Internet network, or other similar type of network environment. The network 1765 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 1701 is a PC, workstation, intelligent device or the like, the software in the memory 1710 may further include a basic input output system (BIOS) (omitted for simplicity). The BIOS is a set of essential software routines that initialize and test hardware at startup, start the OS 1711, and support the transfer of data among the hardware devices. The BIOS is stored in ROM so that the BIOS can be executed when the computer 1701 is activated.

When the computer 1701 is in operation, the processor 1705 is configured to execute software stored within the memory 1710, to communicate data to and from the memory 1710, and to generally control operations of the computer 1701 pursuant to the software. The template inheritance and linking methods described herein and the OS 1711, in whole or in part, but typically the latter, are read by the processor 1705, perhaps buffered within the processor 1705, and then executed.

When the systems and methods described herein are implemented in software, as is shown in FIG. 17, the methods can be stored on any computer readable medium, such as storage 1720, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional functional or procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the template inheritance and linking methods are implemented in hardware, the template inheritance and linking methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include a decrease in template database size since properties don't have to be redefined in each template. In adding, updating, or removing properties on templates are performed only in a few base templates rather than in all of the templates in the databases.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for generating templates in a programming environment, the method comprising:
generating a first template having a plurality of object definitions;
defining properties for the object definitions within the first template; and
deriving a second template from the first template, wherein the properties of the first template are defined in the second template,
wherein the first template includes a link to a template link object that links to the second template.

2. The method as claimed in claim 1 defining an inheritance of an object type definition in the second template independent of other of the plurality of object type definitions.

3. The method as claimed in claim 1 further comprising generating object instances within the first template.

4. The method as claimed in claim 3 further comprising generating object instances within the second template.

5. The method as claimed in claim 3 further comprising adding to the first template, a reference to the second template.

6. The method as claimed in claim 4 wherein an object instance in the second template is generated by replacing the template link object in the second template with an object instance from the first template

7. The method as claimed in claim 1 wherein the second template inherits the properties from the object definitions from the first template.

8. The method as claimed in claim 7 wherein the second template includes a second property value for an object instance derived from an object in the first template and having a first value.

9. The method as claimed in claim 8 further comprising setting the property value in the second object instance derived from an object in the first template to the second property value.

10. The method as claimed in claim 1 wherein object instances generated in the second template follow the object type definitions within the first template.

11. A computer program product for generating templates in a programming environment, the computer program product having a computer readable medium including instructions for causing a computer to implement a method, the method comprising:
generating a first template having a plurality of object definitions;
defining properties for the object definitions within the first template; and
deriving a second template from the first template, wherein the properties of the first template are defined in the second template,
wherein the first template includes a link to a template link object in the second template.

12. The computer program product as claimed in claim 11 generating an inheritance of an object type definition in the second template independent of other of the plurality of object type definitions.

13. The computer program product as claimed in claim 11 further comprising generating object instances within the first template.

14. The computer program product as claimed in claim 13 further comprising generating object instances within the second template.

15. The computer program product as claimed in claim 3 wherein the method further comprises adding to the first template, a reference to the second template.

16. The computer program product as claimed in claim 14 wherein an object instance in the second template is generated by replacing the template link object in the second template with an object instance from the first template.

17. The computer program product as claimed in claim 11 wherein the second template inherits the properties from the object type definitions from the first template.

18. The computer program product as claimed in claim 17 wherein the second template includes a second property value for an object instance derived from the first template and having a first value.

19. The computer program product as claimed in claim 18 further comprising setting the object instance derived from the first template to the second property value.

20. The computer program product as claimed in claim 11 wherein object instances generated in the second template follow the object type definitions within the first template.
